(19) United States
(12) Patent Application Publication
(10) Pub. No.: US 2026/0087805 A1
(43) Pub. Date: Mar. 26, 2026

(54) FINE-GRAINED VIDEO UNDERSTANDING VIA EXTERNAL MEMORY USING NEURAL SAMPLING

(71) Applicant: Samsung Electronics Co., Ltd., Suwon-si (KR)

(72) Inventor: Saket Gurukar, Irvine, CA (US)

(21) Appl. No.: 19/057,427

(22) Filed: Feb. 19, 2025

Related U.S. Application Data
(60) Provisional application No. 63/698,860, filed on Sep. 25, 2024.

(51) Int. Cl. G06V 20/40; G06N 3/096; G06V 10/82

(52) U.S. Cl. CPC G06V 20/41; G06N 3/096; G06V 10/82

(57) ABSTRACT

A method includes receiving a query at a query module and producing a query module output. The method also includes receiving a video at an external memory module. The method also includes generating a pool of video tokens from the video. The method also includes performing neural sampling to sample the pool of video tokens using a neural sampler in the memory sampling module. The method also includes storing the sampled video tokens in the external memory module. The method also includes providing a response to the query based on the sampled video tokens stored in the external memory module.

### CROSS-REFERENCE TO RELATED APPLICATIONS AND CLAIM OF PRIORITY

This application claims priority under 35 U.S.C. § 119(e) to U.S. Provisional Patent Application No. 63/698,860 filed on Sep. 25, 2024. This provisional patent application is hereby incorporated by reference in its entirety.

### TECHNICAL FIELD

This disclosure relates generally to machine learning systems and processes. More specifically, this disclosure relates to fine-grained video understanding via external memory using neural sampling.

### BACKGROUND

The increase in availability of video recording devices has led to an explosion of video content, with devices capturing vast amounts of footage which are often record lengthy, unstructured, and unedited videos. For modern devices, searching and retrieving specific content from videos is necessary for various practical applications. Video understanding models may be used for such purposes and may operate on videos spanning short amounts of time due to limited GPU memory. For a longer video, video understanding models either randomly sample a limited number of frames from the video, or divide the video into multiple clips, process the clips to produce intermediate results, and aggregate the intermediate results. Both of these approaches are inefficient and may produce inaccurate results as the model likely omits relevant frames.

Accordingly, there is a need for systems and methods for fine-grained video understanding that overcome these challenges.

### SUMMARY

The present disclosure relates generally to machine learning systems and processes and, more specifically, to fine-grained video understanding via external memory using neural sampling.

In one embodiment, a method includes receiving a query at a query module and producing a query module output. The method also includes receiving a video at an external memory module. The method also includes generating a pool of video tokens from the video. The method also includes performing neural sampling to sample the pool of video tokens using a neural sampler in the memory sampling module. The method also includes storing the sampled video tokens in the external memory module. The method also includes providing a response to the query based on the sampled video tokens stored in the external memory module.

In another embodiment, an electronic device includes at least one processing device. The at least one processing device is configured to cause the electronic device to receive a query at a query module and produce a query module output. The at least one processing device is also configured to receive a video at an external memory module. The at least one processing device is also configured to generate a pool of video tokens from the video. The at least one processing device is also configured to perform neural sampling to sample the pool of video tokens using a neural sampler in the memory sampling module. The at least one processing device is also configured to store the sampled video tokens in the external memory module. The at least one processing device is also configured to provide a response to the query based on the sampled video tokens stored in the external memory module.

In yet another embodiment, a non-transitory machine readable includes instructions that when executed by at least one processor of an electronic device, causes the electronic device to receive a query at a query module and producing a query module output, receive a video at an external memory module, generate a pool of video tokens from the video, perform neural sampling to sample the pool of video tokens using a neural sampler in the memory sampling module, store the sampled video tokens in the external memory module, and provide a response to the query based on the sampled video tokens stored in the external memory module.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example network configuration including an electronic device according to an embodiment of the present disclosure;

FIG. 2 illustrates an example system according to an embodiment of the present disclosure;

FIG. 3 illustrates an example video understanding system according to an embodiment of the present disclosure;

FIG. 4 illustrates an example method for fine-grained video understanding via an external memory using neural sampling according to an embodiment of the present disclosure;

FIG. 5A illustrates an example electronic system 500 supporting video understanding via external memory using neural sampling according to an embodiment of the present disclosure; and

FIG. 5B illustrates an example electronic system 550 supporting video understanding via external memory using neural sampling according to an embodiment of the present disclosure.

### DETAILED DESCRIPTION

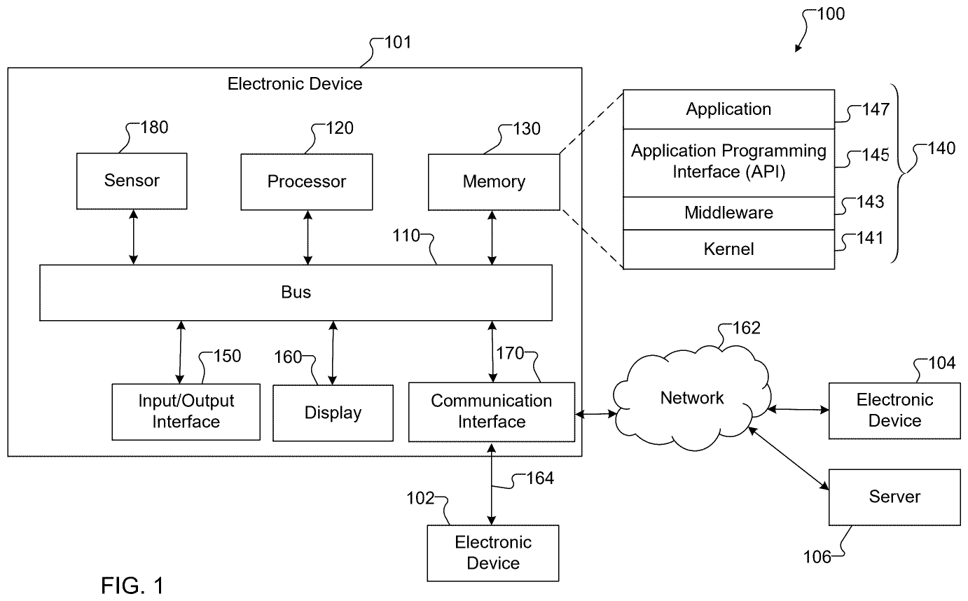

FIGS. 1 through 5B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, the proliferation of video recording devices has led to an explosion of video content, with devices such as smartphones, smart home cameras, autonomous robots, and augmented reality (AR) glasses and virtual reality (VR) assistants capturing vast amounts of footage. These devices often record lengthy, unstructured, and unedited videos, resulting in a vast and complex repository of visual data. Further, searching and retrieving specific content from videos is necessary for various practical applications, yet poses significant technical challenges.

Video understanding models that search and retrieve content from videos may operate on videos spanning short amounts of time, e.g., from a few seconds to about five minutes. The short-duration operational capacity of these models is due to the limited GPU memory. For a longer video, video understanding models can use one of two approaches: i) randomly sample a limited number of frames from the video, or ii) divide the video into multiple clips, process the clips to produce intermediate results, and aggregate the intermediate results. Randomly sampling a limited number of frames is inefficient as the random sampling might omit the key frames important for video understanding. Dividing the video into multiple clips and processing to produce intermediate results is inefficient for videos where understanding of “multiple ordered short-term actions” is required. For example, in case of shoplifting in a supermarket, it is important to understand a customer has taken a product and left the supermarket without paying for the product. Importantly, the video understanding model needs to consider multiple short clips, the order among clips, and the fine-grained relationship among entities in clips.

As limited GPU memory hinders the processing of long-form videos, simply using more GPUs to process long-form videos increases the processing cost and system complexity. As mentioned previously, long-form videos are ubiquitous and there is a lack of an efficient approach that can perform video question answering on long-form videos.

The present disclosure provides for systems and methods for fine-grained video understanding that overcome these challenges. In particular, the present disclosure provides a model that can perform fine-grained video understanding using differentiable neural sampling to sample discriminative video tokens from a pool of available video tokens stored in an external memory. An encoder-decoder module is trained to predict responses to a query based on the external memory. Since the external memory is independent of the length of input video, the model of the present disclosure is capable of processing extremely long videos, e.g., videos with a duration up to 60 minutes. Further, the model of the present disclosure includes using a continual learning-based loss that computes the sampler reward based on model performance on a current query and past queries. The use of the continual learning-based loss further improves the accuracy of responses produced by the model.

FIG. 1 illustrates an example network configuration 100 including an electronic device according to an embodiment of the present disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to fine-grained video understanding via external memory using neural sampling.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to fine-grained video understanding via external memory using neural sampling. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second external electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the second external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to fine-grained video understanding via external memory using neural sampling.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

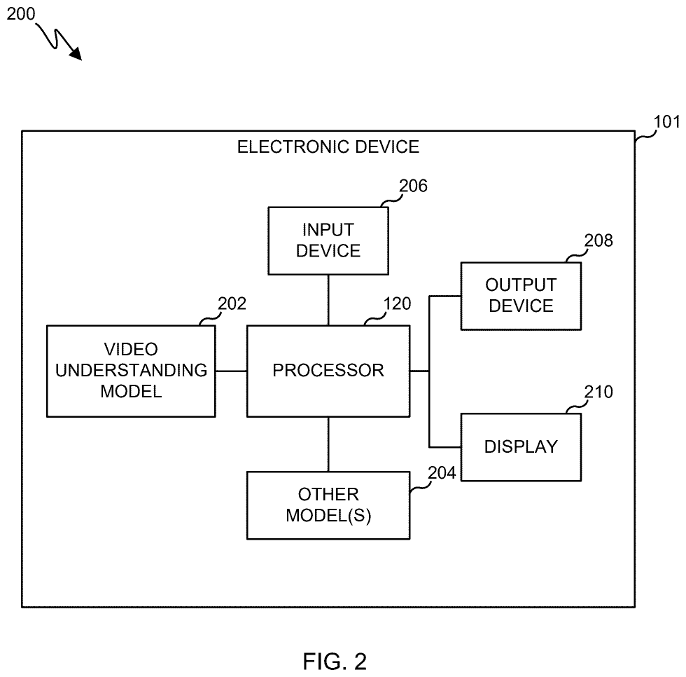

FIG. 2 illustrates an example system 200 according to an embodiment of the present disclosure. For case of explanation, the system 200 is described as involving the use of the electronic device 101 in the network configuration 100 of FIG. 1. However, the system 200 may be used with any other suitable device (such as the server 106) or a combination of devices (such as the electronic device 101 and the server 106) and in any other suitable system(s).

As shown in FIG. 2, the system 200 includes the electronic device 101, which includes the processor 120. The processor 120 is operatively coupled to or otherwise configured to use one or more machine learning models, such as a video understanding model 202. As further described in this disclosure, the video understanding model 202 can include various components and sub-models, such as a speech recognition model. The video understanding model 202 can receive an input, and the video understanding model 202 can operate to perform video understanding depending on the context or application. The video understanding model 202 can generate an output used to perform an action by the electronic device 101 requested in the input.

The processor 120 can also be operatively coupled to or otherwise configured to use one or more other machine learning models 204, such as other models related to automated speech recognition or voice assistant processes. It will be understood that the machine learning models 204 can be stored in a memory of the electronic device 101 (such as the memory 130) and accessed by the processor 120 to perform automated speech recognition tasks, spoken language understanding tasks, and/or other tasks. However, the machine learning models 204 can be stored in any other suitable manner.

The system 200 also includes an input device 206 (such as a keyboard or microphone), an output device 208 (such as a speaker or headphones), and a display 210 (such as a screen or a monitor like the display 160). The processor 120 receives an input from the input device 206 and provides the input to the video understanding model 202. The video understanding model 202 processes the input and outputs a result to the processor 120. The processor 120 may instruct one or more further actions that correspond to one or more instructions or requests provided in the utterance.

Although FIG. 2 illustrates one example of a system 200, various changes may be made to FIG. 2. For example, in some embodiments, the input device 206, the output device 208, and the display 210 can be connected to the processor 120 within the electronic device 101, such as via wired connections or circuitry. In other embodiments, the input device 206, the output device 208, and the display 210 can be external to the electronic device 101 and connected via wired or wireless connections. Also, in some cases, the video understanding model 202 and one or more of the other machine learning models 204 can be stored as separate models called upon by the processor 120 to perform certain tasks or can be included in and form a part of one or more larger machine learning models. Further, in some embodiments, one or more of the models, such as the video understanding model 202 or one or more of the other machine learning models 204, can be stored remotely from the electronic device 101, such as on the server 106. Here, the electronic device 101 can transmit requests including inputs to the server 106 for processing of the inputs using the machine learning models, and the results can be sent back to the electronic device 101. In addition, in some embodiments, the electronic device 101 can be replaced by the server 106, which receives audio inputs from a client device and transmits instructions back to the client device to execute functions associated with instructions included in utterances.

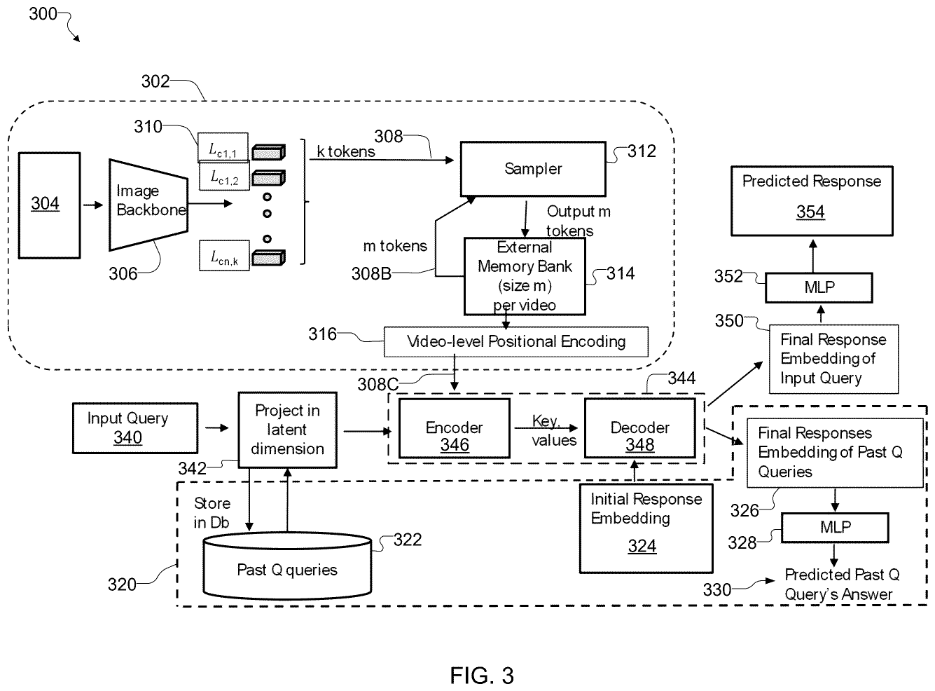

FIG. 3 illustrates an example video understanding system 300 according to an embodiment of the present disclosure. In particular, the video understanding system 300 may be used by the processor 120 of the electronic device 101 of FIG. 1 to perform video understanding functions, e.g., in response to a query by a user or in operations by other applications.

As shown in FIG. 3, the video understanding system 300 includes a memory sampling module 302. The memory sampling module 302 includes an input video sequence 304, an image backbone 306, latent tokens 308, a neural sampler 312, an external memory bank 314, and a video-level positional encoder 316. The memory sampling module 302 receives the input video sequence 304 and processes it using the image backbone 306, tokenizing a plurality of clips 310 of the input video sequence 304 to produce the latent tokens 308. For example, for a relational space-time (ReST) input query 340, there are three types of ReST input queries 340: an activity input query, an object input query, and a time input query. Depending on the type of input query 340, a user provides the two aspects as input and expects the video understanding system 300 to answer the third aspect. In the REST input query 340 example, the video understanding system 300 uses latent representation of activity and time aspects through linear layers while the object aspect latent representation is processed through the image backbone 306.

For processing of the input video sequence 304, every input query 340 may have a query start (qₛ) and a query end (qₑ) time as input. The memory sampling module 302 samples a clip 310 with a clip start (cₛ) and clip end time (cₑ) such that the clip start and clip end time are within the query start and query end times (qₛ<=cₛ<=cₑ<=qₑ). A clip size of the sampled clip is small enough to accommodate the available GPU memory. The sampled frames of the clip 310 are processed by the image backbone 306 at a target frame per second (fps), e.g., 5 fps. For example, the image backbone 306 may be a pretrained resnet-101. The input to image backbone 306 includes <C, T, H, W> where C is the number of channels, T is the number of frames of the clip 310, H and W are the height and width of the frame. The output of the image backbone 306 is <d, T, h, w> where d is the image backbone 306 feature, h and w are reduced height and weight of the frame. This results in individual latent tokens 308 (k=h*w*T) with dimensionality d.

The latent tokens 308 are then supplied to the neural sampler 312. For example, the individual latent tokens 308 of the clip 310 are passed through a learnable neural sampler 312. For example, the neural sampler 312 may be a neural conditional Poisson networks or another differentiable neural sampler configured to discriminately sample the video tokens. Other neural samplers are contemplated as part of this disclosure. Each input video sequence 304 has an external memory of size m. A clip 310 is sampled from the input video sequence 304. The neural sampler 312 receives the latent tokens 308 and m memory tokens 308A from the external memory bank 314 relevant to the input video sequence 304. The neural sampler 312 then samples m memory tokens 308A from a pool of m+k latent tokens 308. The sampled tokens 308B are then passed through video-level positional encoder 316 to retrieve positional embeddings to produce discriminative tokens 308C.

Regarding inferencing, all the latent tokens 308 of the input video sequence 304 are passed through the neural sampler 312 once. The discriminative tokens 308C are stored in external memory along with their absolute video positional encoding. All the queries related to the input video sequence 304 are directly answered only through the tokens, e.g., the sampled tokens 308B or the discriminative tokens 308C, stored in the external memory bank.

Depending on the type of the relational space-time input query 340, a sequence is constructed based on the sampled tokens 308B and the projected two-aspect embeddings. The constructed sequence is passed through a transformer encoding-decoding module 344.

The video understanding system 300 also includes a continual learning module 320. The continual learning module 320 includes a past query database 322, an initial response embedding module 324, a final past response embedding module 326, and a first multi-layer perceptron module 328 configured to produce a MLP output 330. The neural sampler 312 is rewarded if the video understanding system 300 can answer current input query 340. However, this may add bias in the neural sampler 312 to give more weightage to the latent tokens 308 of current clip 310. The neural sampler 312 should sample representative video latent tokens 308 of the whole of the input video sequence 304, not just of current clip 310. To reduce this bias, the continual learning module 320 uses a streaming approach. After processing an input query 340, the input query 340 is added to a queue of size Q. As such, the neural sampler 312 will sample latent tokens 308 such that the video understanding system 300 can correctly answer the current input query 340 as well as past Q queries.

The video understanding system 300 receives an input query 340 and processes the input query 340 in a latent dimension projection module 342. The latent dimension projection module 342 receives past Q queries form the past query database 322 of the continual learning module 320 as well as storing a copy of the input query 340 into the past query database 322. Once the input query 340 is projected in a latent dimension, the input query 340 is processed by the encoding-decoding module 344. In particular, the input query 340 is encoded in the encoder 346 along with the discriminative tokens 308C from the memory sampling module 302. The constructed sequence is passed through a transformer encoding-decoding module 344 having an encoder 346 and a decoder 348. However, rather than using fixed number of queries, the variable length queries are passed through the encoding-decoding module 344 where the length of queries depends on the clip time, e.g., the clip start cₛ and clip end cₑ times. The output of the decoder 348 are embeddings, e.g., Ecₛ, . . . , Ecₑ, that has a length equal to the variable length queries that are passed through as input. For example, the output representation for an activity and a time query of the input query 340 are aggregated. The input query 340 is encoded with key values and processed by the decoder 348. The decoder 348 receives embedding information from the initial response embedding module 324 of the continual learning module 320. The decoder 348 embeds a response to the input query 340. The decoder 348 the produces a final response for embedding and sends a copy of the final response to final past response embedding module 326 of the continual learning module 320 and another copy to a final query response embedding module 350.

Each copy of the final response is sent to a multi-layer perceptron. For example, the copy of the response sent to the final past response embedding module 326 is subsequently sent to the first multi-layer perceptron module 328 to produce the MLP output 330. The copy of the response sent to the final query response embedding module 350 is subsequently sent to a second multi-layer perceptron module 352 to produce an output 354 that is ultimately presented to a user as a response to the input query 340 and based on the input video sequence 304. For example in the second multi-layer perceptron module 352, for object query of the input query 340, which may require frame-level predictions, each individual input query 340 embedding Ecₛ, . . . , Ecₑ is passed through an MLP, e.g., the first multi-layer perceptron module 328 or the second multi-layer perceptron module 352, for bounding box predictions. For example, the video understanding system 300 may be trained with BCELoss for activity queries, L1 loss for time queries, and generalized IOU loss for object queries.

Although FIG. 3 illustrates a block diagram of an example video understanding system 300, various changes may be made to FIG. 3. For example, various components and functions in FIG. 3 may be combined, further subdivided, replicated, or rearranged according to particular needs. Also, one or more additional components and functions may be included if needed or desired.

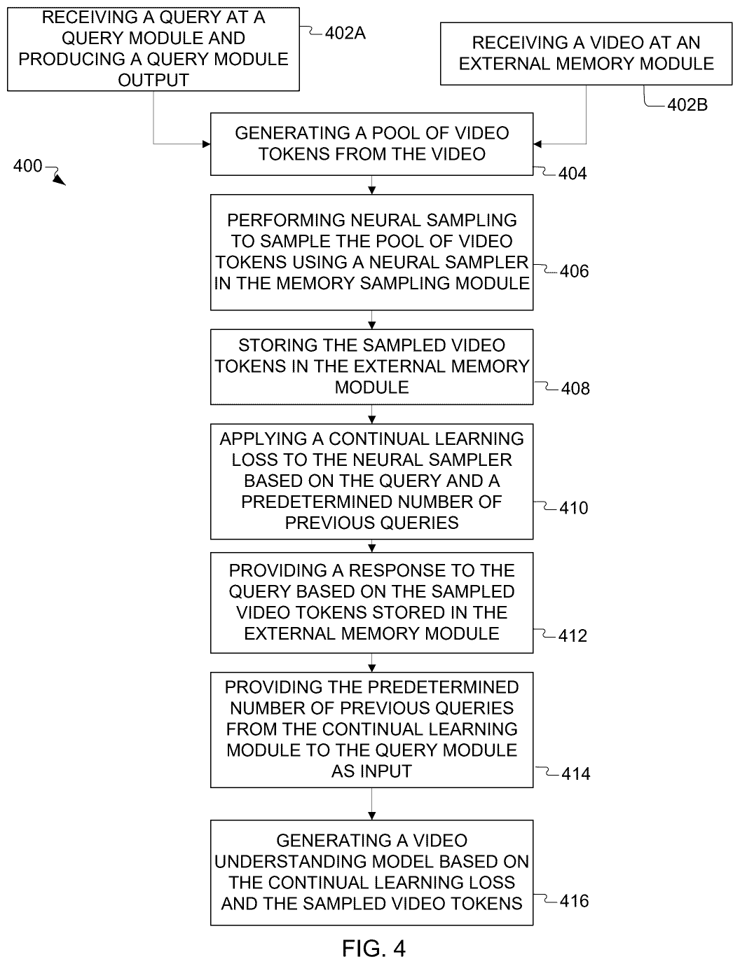

The video understanding system 300 may be used by a processor executing a method of video understanding in response to a user query on an electronic device. For example, the video understanding system 300 may execute a method as shown in FIG. 4.

FIG. 4 illustrates an example method 400 for fine-grained video understanding via an external memory using neural sampling according to an embodiment of the present disclosure. For ease of explanation, the method 400 is described as involving the use of the electronic device 101 in the network configuration 100 of FIG. 1 and the video understanding system 300 of FIG. 3. However, the method 400 may be used with any other suitable electronic device (such as the server 106) or a combination of devices (such as the electronic device 101 and the server 106) and in any other suitable system(s).

As shown in FIG. 4, the method 400 incorporates a neural sampler and an encoding-decoding module that references a database in an external memory to perform video understanding functions without increasing GPU memory consumption of an electronic device while increasing the accuracy of the query response.

In step 402A, a query is received at a query module and producing a query module output. For example, a user may provide a query to the query module which converts the query into an input query, e.g., the input query 340. For example, the query module may include LLM-based models or natural language understanding modules to convert spoken queries into text queries. Alternatively, the query provided by the user may be a text query, such as text input using a keyboard coupled to the query module, which the query module forwards to the 300.

Concurrently or subsequently, in step 402B, a video, e.g., input video sequence 304, is received at by the 300. For example, the 300 may receive the 304 at the 302. For example, the 302 may receive the 304 from a connected recording device, e.g., a connected camera, or from a video database coupled to an electronic device housing the 300.

In step 404, a pool of video tokens is generated from the input video sequence 304. For example, the 306 may be use sampled clips from the 304 to produce individual latent tokens 308 with dimensionality d, as described above. The individual latent tokens 308 produced by the 306 are input into the neural sampler 312 along with m memory tokens 308A from the external memory bank 314 relevant to the input video sequence 304 to produce a pool of m+k latent tokens 308.

In step 406, neural sampling is performed to sample the pool of video tokens using a neural sampler in the memory sampling module. For example, the neural sampler 312 may sample the pool of m+k latent tokens 308, e.g., using neural conditional Poisson networks.

In step 408, the sampled video tokens are stored in the external memory module. For example, the sampled tokens 308B are passed through video-level positional encoder 316 to retrieve positional embeddings to produce discriminative tokens 308C. The discriminative tokens 308C are stored in external memory along with their absolute video positional encoding. This allows all queries related to the input video sequence 304 to be directly answered only through the sampled tokens 308B or the discriminative tokens 308C stored in the external memory bank.

In step 410, a predetermined number of previous queries are provided as input from the continual learning module to the latent dimension projection module 342. For example, the past Q queries are added, as well as the input query 340, to form a queue of size Q. The neural sampler 312 will sample latent tokens 308 such that the video understanding system 300 can correctly answer the current input query 340 as well as past Q queries.

In step 412, a continual learning loss is applied to the neural sampler based on the query and the predetermined number of previous queries. For example, the continual learning-based loss computes the neural sampler reward based on model performance on current query 340 and past Q queries. As an example, the reward signal may be lowered to indicate to the neural sampler 312 that the applied sampling weight to the past Q queries is too low. In these situations, the continual learning loss is higher, corresponding to the lower reward signal.

In step 414, a response to the query is provided. For example, after embedding in the encoding-decoding module 344, the video understanding system 300 may pass the response through the second multi-layer perceptron module 352 before providing the final response to the user, e.g., by displaying the response on a display device.

In step 416, a video understanding model is generated based on applying the continual learning loss to the neural sampler and storing the sampled video tokens in the external memory bank 314. For example, the continual learning loss may be used to maintain the sampling weights of the neural sampler 312. The sampled video tokens are stored in the external memory module and may be recalled for subsequent queries related to the input video sequence. The video understanding model may then be generated by using the continual learning loss and the stored video tokens to respond to further queries.

An advantage of the disclosed method 400 is that, unlike the methods that randomly sampling a limited number of frames for a video, the neural sampler 312 samples the entire input video sequence 304 without expanding GPU memory. This allows for improved accuracy of responses to queries as important moment are not accidentally omitted.

Although FIG. 4 illustrates one example fine-grained video understanding method 400, various changes may be made to FIG. 4. For example, while shown as a series of steps, various steps in FIG. 4 could overlap, occur in parallel, occur in a different order, or occur any number of times.

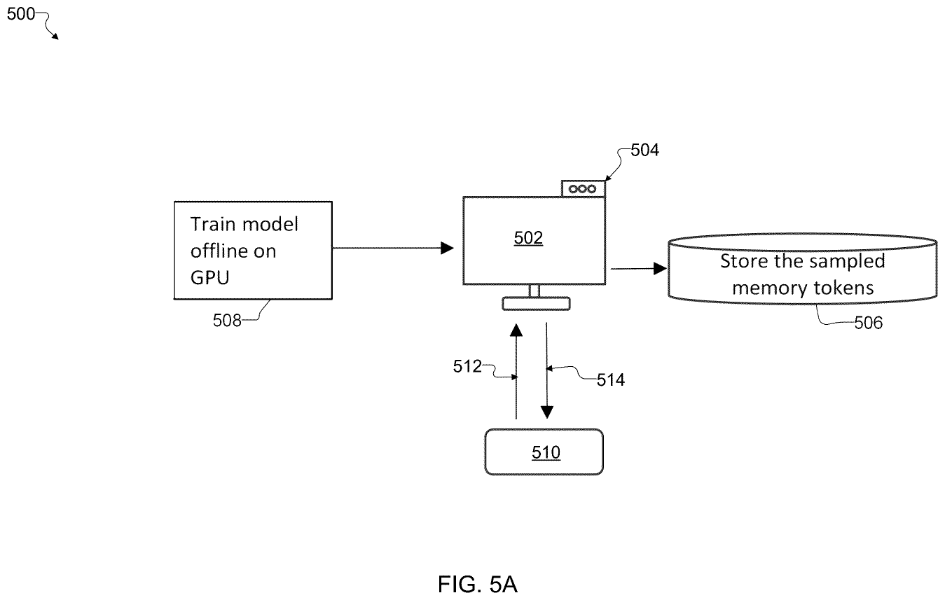

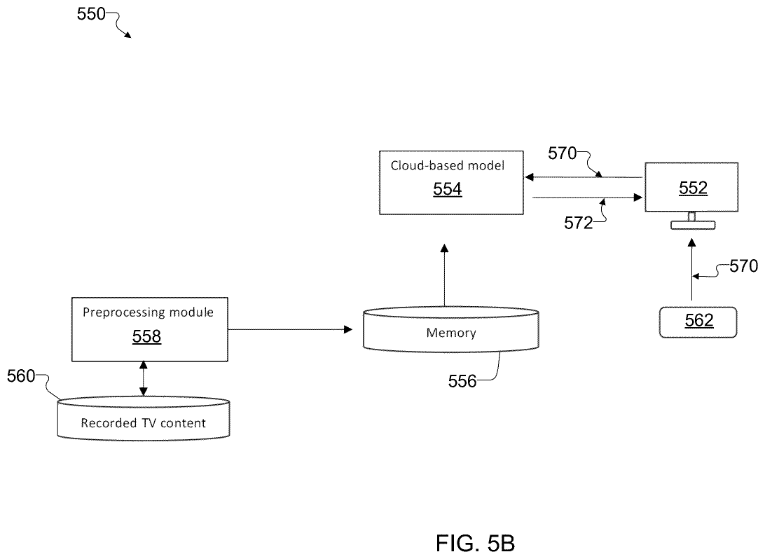

FIG. 5A illustrates an example electronic system 500 supporting video understanding via external memory using neural sampling according to an embodiment of the present disclosure. FIG. 5B illustrates an example electronic system 550 supporting video understanding via external memory using neural sampling according to an embodiment of the present disclosure. Both electronic system 500 and electronic system 550 may include the 300 of FIG. 3 but are not limited to only the embodiment of the 300.

As shown in FIG. 5A, the electronic system 500 may include a display device 502 operably coupled to a video recording device 504, an external memory 506, and a video understanding model 508. The display device 502 may be a television, smartphone, or other suitable display device. The display device 502 can capture visual data, e.g., using the video recording device 504, and a user 510 may input one or more queries query 512 through various interfaces, such as a TV screen keyboard, a connected electronic device, e.g., a smartphone, or an audio input device. In this example embodiment, the video understanding model 508 is configured similar to the 300 described in FIG. 3 unless otherwise described. The video understanding model 508 may be trained offline on a GPU memory which may then be deployed on the display device 502. In the on-device setup, the inference, e.g., the storage of the discriminative tokens 308C, can be done on a central processing unit of the display device 502 to produce a response 514.

The electronic system 500 illustrates an example embodiment of a video understanding model 508 that is house locally on the display device 502 to protect user privacy as the recorded content from the video recording device 504 is private to user. However, embodiments of the present disclosure are not limited to the video understanding model to be locally stored. For example, the video understanding model and related processing may be stored remotely, e.g., may be cloud-based, as illustrated in FIG. 5B.

As shown in FIG. 5B, the electronic system 550 includes a display device 552 operably coupled to a cloud-based model 554. The cloud-based model 554 is configured to support fine-grained video understanding via external memory using neural sampling similar to the video understanding system 300 of FIG. 3, unless otherwise described. The cloud-based model 554 is further coupled to an external memory 556 which is coupled to a preprocessing module 558 which, in turn, is coupled to a video database 560 of recorded content. The preprocessing module 558 includes a neural sampler, e.g., the neural sampler 312 of FIG. 3, and is configured to perform neural sampling on the recorded content of the video database 560 and provide discriminative tokens 308C to the cloud-based model 554. A user 562 may input a query 570 to the display device 552. The display device 552 may then forward the query 570 to the cloud-based model 554 for video understanding processing. The cloud-based model 554 produces a response 572 and transmits the response 572 to the display device 552. The display device 552 may then display the response 572 to the user 562.

The electronic system 550 may be used, for example, in situations where the long-form video is a movie or TV show or sports content. The user might be interested in asking several questions such as when did the action or drama happened between actors. This example embodiment of electronic system 550 is particularly useful in situations where video content is large and cannot be stored on the limited memory available on display device 552.

In either the electronic system 500 or the electronic system 550, the video understanding model 508 may be used, for example, for long video question answering. In some cases, this may include performing searches within videos.

As an additional example, the video understanding model 508 may be used for interactive seek functions on TV streaming. For example, users may be interested in seeking or scrubbing a video to a time when an event happens. The video understanding model will identify the time during which this event happens to provide an input to an interactive seek application to perform the seeking action. Other use cases, such as quality control in manufacturing or on-premises video surveillance on an edge device, are also contemplated as part of this disclosure.

Although FIGS. 5A and 5B illustrate examples of an electronic system supporting video understanding via an external memory using neural sampling, various changes may be made to FIGS. 5A and 5B. For example, various components and functions in FIGS. 5A and 5B may be combined, further subdivided, replicated, or rearranged according to particular needs. Also, one or more additional components and functions may be included if needed or desired.

The present disclosure provides for a systems and methods for fine-grained video understanding that improve accuracy of the video understanding model responses to a query that may be based on long-form videos, e.g., videos with lengths up to 60 minutes. The video understanding module uses a neural sampler and an encoder-decoder module to tokenize an input video and store the video token in an external memory where an encoder-decoder module predicts responses based on the video tokens to produce accurate responses to a query for long-form videos without increasing GPU memory.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving a query at a query module and producing a query module output;
receiving a video at an external memory module;
generating a pool of video tokens from the video;
performing neural sampling to sample the pool of video tokens using a neural sampler in the memory sampling module;
storing the sampled video tokens in the external memory module; and
providing a response to the query based on the sampled video tokens stored in the external memory module.

2. The method of claim 1, wherein the neural sampler is a differentiable neural sampler configured to discriminately sample the video tokens.

3. The method of claim 1, further comprising:
applying a continual learning loss using a continual learning module to the neural sampler based on the query and a predetermined number of previous queries.

4. The method of claim 3, further comprising:
providing the predetermined number of previous queries from the continual learning module to the query module as input.

5. The method of claim 3, wherein storing the sampled video tokens in the external memory module comprises storing a position encoding for each of the sampled video tokens.

6. The method of claim 3, further comprising:
generating a video understanding model based on applying the continual learning loss to the neural sampler and storing the sampled video tokens in the external memory module.

7. The method of claim 6, wherein the video understanding model is stored on a display device.

8. An electronic device, comprising:
at least one processing device configured to:
receive a query at a query module and produce a query module output;
receive a video at an external memory module;
generate a pool of video tokens from the video;
perform neural sampling to sample the pool of video tokens using a neural sampler in the memory sampling module;
store the sampled video tokens in the external memory module; and
provide a response to the query based on the sampled video tokens stored in the external memory module.

9. The electronic device of claim 8, wherein the neural sampler is a differentiable neural sampler configured to discriminately sample the video tokens.

10. The electronic device of claim 8, wherein the processor is further configured to cause the electronic device to apply a continual learning loss using a continual learning module to the neural sampler based on the query and a predetermined number of previous queries.

11. The electronic device of claim 10, wherein the processor is configured to cause the electronic device to provide the predetermined number of previous queries from the continual learning module to the query module as input.

12. The electronic device of claim 10, wherein, to store the sampled video tokens in the external memory module, the at least one processing device is further configured to cause the electronic device to store a position encoding for each of the sampled video tokens.

13. The electronic device of claim 10, wherein the processor is further configured to cause the electronic device to generate a video understanding model based on applying the continual learning loss to the neural sampler and storing the sampled video tokens in the external memory module.

14. The electronic device of claim 13, wherein the video understanding model is stored on a display device of the electronic device.

15. A non-transitory machine readable medium comprising instructions that when executed by at least one processor of an electronic device, causes the electronic device to:
receive a query at a query module and producing a query module output;
receive a video at an external memory module;
generate a pool of video tokens from the video;
perform neural sampling to sample the pool of video tokens using a neural sampler in the memory sampling module;
store the sampled video tokens in the external memory module; and
provide a response to the query based on the sampled video tokens stored in the external memory module.

16. The non-transitory machine readable medium of claim 15, wherein the neural sampler is a differentiable neural sampler configured to discriminately sample the video tokens.

17. The non-transitory machine readable medium of claim 15, wherein the instructions further comprise instructions that, when executed by the at least one processor, cause the electronic device to apply a continual learning loss using a continual learning module to the neural sampler based on the query and a predetermined number of previous queries.

18. The non-transitory machine readable medium of claim 17, wherein the instructions further comprise instructions that, when executed by the at least one processor, causes the electronic device to provide the predetermined number of previous queries from the continual learning module to the query module as input.

19. The non-transitory machine readable medium of claim 17, wherein the instructions that, when executed by the at least one processor, causes the electronic device to store the sampled video tokens in the external memory module, comprise instructions, that when executed by the at least one processor, cause the electronic device to store a position encoding for each of the sampled video tokens.

20. The non-transitory machine readable medium of claim 17, wherein the instructions further comprise instructions that, when executed by the at least one processor, cause the electronic device to generate a video understanding model based on applying the continual learning loss to the neural sampler and storing the sampled video tokens in the external memory module.
